(19) United States
(12) Patent Application Publication
(10) Pub. No.: US 2026/0277927 A1
(43) Pub. Date: Sep. 17, 2026

(54) EFFICIENT MASS MODELING OF MAPPINGS IN ELECTRONIC DATA INTERCHANGE

(71) Applicant: SAP SE, Walldorf (DE)

(72) Inventors: Stefan Boller, Heidelberg (DE); Joerg Ackermann, Heidelberg (DE); Gunther Stuhec, Heidelberg (DE)

(21) Appl. No.: 19/254,638

(22) Filed: Jun. 30, 2025

Related U.S. Application Data
(60) Provisional application No. 63/772,425, filed on Mar. 14, 2025.

(51) Int. Cl. G06F 16/25

(52) U.S. Cl. CPC G06F 16/258

(57) ABSTRACT

In a computer-implemented method for electronic data interchange (EDI), a base mapping representing commonality between a source and target data structure is generated. Based on the base mapping, a partner-specific overlay mapping is generated for a data exchange partner referring to the base mapping and containing mapping elements specific to the data exchange partner and different from the base mapping. Changes made to the base mapping is applied automatically to all partner-specific overlay mappings.

### CLAIM OF PRIORITY

This application claims priority under 35 USC § 119(e) to U.S. patent application Ser. No. 63/772,425, filed on Mar. 14, 2025, the entire contents of which are hereby incorporated by reference.

### BACKGROUND

In electronic data interchange (EDI), entities (e.g., organizations, companies, and scientific research) often interchange data (e.g., files) with several hundred or even thousand different partners. Since not all will likely use the same data interchange format, mappings between the one entity's data format and those of its partners are necessary. While many of partners may use similar data exchange formats which differ only in minor details, creating and maintaining a large number of mappings in an efficient way is important for proper data interchange and accuracy.

### SUMMARY

The present disclosure describes efficient mass modeling of mappings in electronic data interchange (EDI).

In an implementation, a computer-implemented method for electronic data interchange (EDI), comprising: generating a base mapping representing commonality between a source and target data structure; generating, based on the base mapping, a partner-specific overlay mapping for a data exchange partner referring to the base mapping and containing mapping elements specific to the data exchange partner and different from the base mapping; and applying, automatically, changes made to the base mapping to all partner-specific overlay mappings.

The described subject matter can be implemented using a computer-implemented method; a non-transitory, computer-readable medium storing computer-readable instructions to perform the computer-implemented method; and a computer-implemented system comprising one or more computer memory devices interoperably coupled with one or more computers and having tangible, non-transitory, machine-readable media storing instructions that, when executed by the one or more computers, perform the computer-implemented method/the computer-readable instructions stored on the non-transitory, computer-readable medium.

The subject matter described in this specification can be implemented to realize one or more of the following advantages. Currently, a type of manual base/overlay mapping approach is used. This means that one mapping is created as base mapping and is used as a copy template to create further partner-specific mappings. The partner-specific mappings can then be edited according to the needs of a corresponding partner. First, the new approach avoids the need to manually make each change in the base mapping for all partner-specific mappings through the use of automation. This helps mitigate a very resource intensive and error prone process. The new approach allows the creation of a base mapping which contains the common mapping elements which are needed for most of the partners. Based on the base mapping, a set of partner-specific overlay mappings can be created which contains only mapping elements which are specific for a particular partner. Overlay mappings can define new mapping elements, remove base mapping elements, and redefine base mapping elements. Second, the new approach permits partner-specific mappings can be easily regenerated along with updated corresponding runtime configurations. Executables can be generated based on the base and overlay mappings, which can be executed by any transformer (e.g., XSLT). In some implementations, there are two options as to how these executables can be generated: 1) either as a combined base-overlay mapping executable or 2) in a way such that the overlay mapping executables use the base mapping executable. The latter option also allows an efficient maintenance of base/overlay mappings, because if a change is made for a base mapping only, the base mapping executable needs to be regenerated and all overlay mappings can immediately use the new base mapping executable without a need to be regenerated.

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

FIG. 1 is a user interface (UI) representation of a mapping guideline (MAG), according to an implementation of the present disclosure.

FIG. 2 is a UI representation of an enhanced MAG, according to an implementation of the present disclosure.

FIG. 3 is an example of mapping guidelines 300 UI, according to an implementation of the present disclosure

FIG. 4 is an example of a UI for selecting a MAG type, according to an implementation of the present disclosure.

FIG. 5 is an example of a UI for selecting a base MAG, according to an implementation of the present disclosure.

FIG. 6 is an example of a UI for selecting a source mapping implementation guideline (MIG), according to an implementation of the present disclosure.

FIG. 7 is an example of a UI for selecting a target MIG, according to an implementation of the present disclosure.

FIG. 8 is an example of a UI for performing version conversion, according to an implementation of the present disclosure.

FIG. 9 is an example of a UI for performing a main mapping, according to an implementation of the present disclosure.

FIG. 10 is a block diagram illustrating an example of a computer-implemented system used to provide computational functionalities associated with described algorithms, methods, functions, processes, flows, and procedures, according to an implementation of the present disclosure.

FIG. 11 is a flowchart illustrating an example of a computer-implemented method for efficient mass modeling of mappings in electronic data interchange (EDI), according to an implementation of the present disclosure.

Like reference numbers and designations in the various drawings indicate like elements.

### DETAILED DESCRIPTION

The following detailed description describes efficient mass modeling of mappings in electronic data interchange (EDI) and is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

In EDI, entities (e.g., organizations, companies, and scientific research) often interchange data (e.g., files) with several hundred or even thousand different partners. Since not all will likely use the same data interchange format, mappings between the one entity's data format and those of its partners are necessary. While many of partners may use similar data exchange formats which differ only in minor details, creating and maintaining a large number of mappings in an efficient way is important for proper data interchange and accuracy. An example could be a data fields associated with a sales/delivery invoice or a status report.

For EDI currently, a type of manual base/overlay mapping approach is used. This means that one mapping is created as base mapping and is used as a copy template to create further partner-specific mappings. The partner-specific mappings can then be edited according to the needs of the corresponding partner. However, this approach has two major drawbacks. First, every change in the base mapping must be performed manually in all partner-specific mappings. There is no automation which would apply the changes to the partner-specific mappings. This is a huge effort and very error prone. A second drawback is that all the executables of the partner-specific mappings must be regenerated in such a case and corresponding runtime configurations need to be updated.

The described new approach avoids the need to manually make each change in the base mapping for all partner-specific mappings through the use of automation. A base mapping can be created which contains the common mapping elements which are needed for most of the partners (typically 80-90% of requirements are the same). Based on the base mapping, a set of partner-specific overlay mappings can be created which contains only mapping elements which are specific for a particular partner (where needed). Overlay mappings can define new mapping elements, remove base mapping elements, and redefine base mapping elements.

Additionally, the new approach permits partner-specific mappings to be easily regenerated along with updated corresponding runtime configurations. Executables can be generated based on the base and overlay mappings, which can be executed by any transformer (e.g., Extensible Stylesheet Language Transformations (XSLT)). In some implementations, there are two options as to how these executables can be generated: 1) either as a combined base-overlay mapping executable or 2) in a way such that the overlay mapping executables use the base mapping executable. The latter option also allows an efficient maintenance of base/overlay mappings, because if a change is made for a base mapping only, the base mapping executable needs to be regenerated and all overlay mappings can immediately use the new base mapping executable without a need to be regenerated.

A message implementation guideline (MIG) describes a structure of a customized interface, the meaning of each defined element of an interface, and how each element of payload data is treated or processed according to conventions of the interface. A mapping guideline (MAG) is based on source and target MIGs and permits data to be defined structurally for transfer between software applications/implementations.

Described is a mapping base/overlay mapping-type approach where: 1) one MAG is used as a base reference/blueprint for common mappings; 2) overlay mapping provides a partner-specific MAG where only a delta compared to the base mapping is maintained; 3) any changes to the base mapping is automatically applied (i.e., merged) to all overlay mappings (similar to the concept of inheritance in software programming); and 3) overlay mappings can be defined in a mapping editor (or MAG editor). The mappings are easy to understand for a user and flexible.

In the described approach, a procedure (e.g., a computer software application or a service) can be created to calculate common mappings even between different versions of standards. This calculation is used to generate the base reference/blueprint.

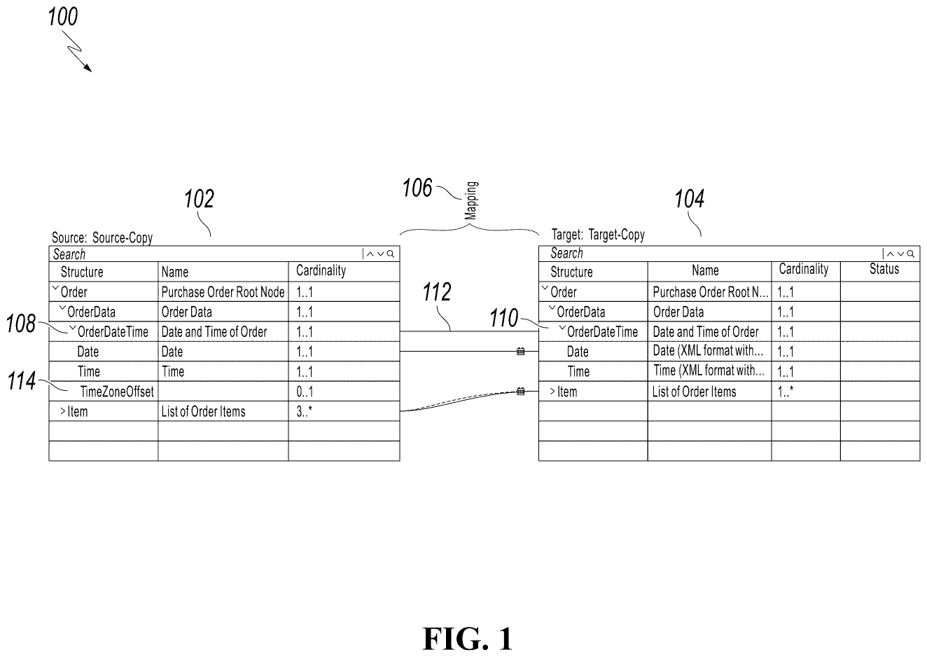

FIG. 1 is a user interface (UI) representation of a mapping guideline (MAG) 100, according to an implementation of the present disclosure. A MAG 100 is a runtime artifact used as a reference or guidance for implementing mapping in an EDI integration application. Data source 102 and data target 104 along with mappings 106 in a UI of a mapping editor. The data source 102 is structurally how the data is received and the data target 104 is structurally how the data is expected. As an example, data type OrderDateTime 108 of data source 102 is mapped (or transformed) to data type OrderDateTime 110 of data target 104 using mapping 112.

While the provided example shows a data source 102 and data target 104 that are relatively similar in structure, in some implementations, data structures can be significantly different and it becomes necessary to create complicated mappings to process the data structures to convert from one data format to another data format. The new approach permits the description of how data is received from a structural Point of view in the mapping editor. Note that the data type OrderDate Time 108 has an additional field TimeZoneOffset 114 that is not present in the data type OrderDateTime 110. This may or may not be important to a particular application. If so, this discrepancy needs to be addressed for proper data transfer.

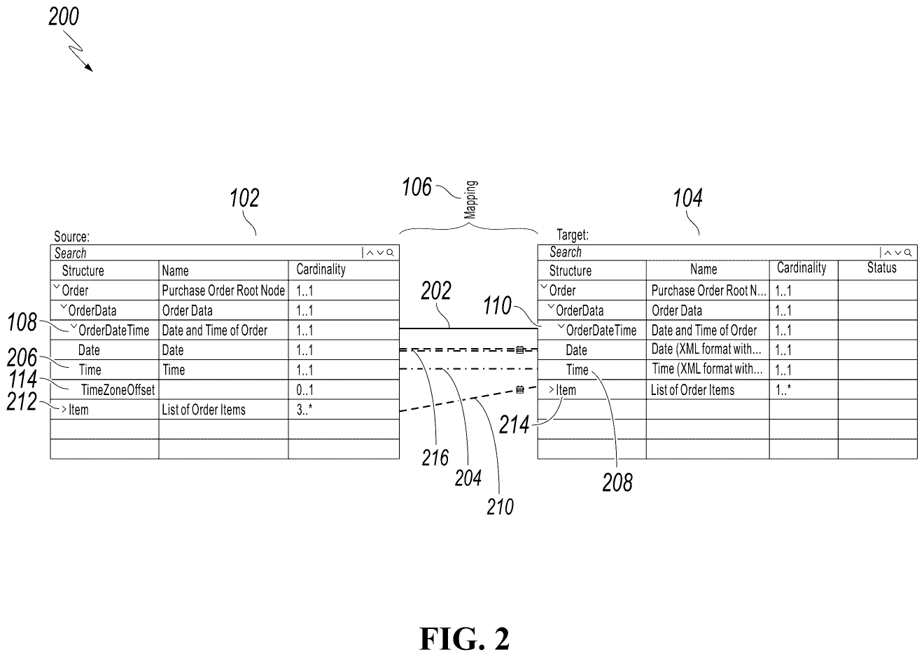

FIG. 2 is a UI representation of an enhanced MAG 200, according to an implementation of the present disclosure.

An overlay mapping refers to a base mapping and all mapping from a base mapping. Available options are: 1) keep a mapping element (e.g., see 202 where the data type OrderDateTime 108 and 110 are kept in the mapping); 2) define a new mapping element (e.g., see 204 as a mapping between data type Time 206 and Time 208); 3) disable/remove a mapping element (e.g., see 210 where a mapping between data type Item 212 and Item 214 is disabled)—either implicitly or explicitly; and 4) replace a mapping element (i.e., disable plus new) (e.g., see 216 represented by two closely parallel lines (one for disable and one for new—consistent with 210 and 204, respectively). Once the mapping is completed, data transformations can take place using the mapping.

In some implementations, an overlay MAG logically consists of mapping elements (ME): all ME from the base mapping—disabled ME plus added ME.

In some implementations, type of changes allowed include: 1) user can perform any type of mapping in a MAG as an overlay mapping allows all mapping features; 2) base mapping elements cannot be changed in an overlay mapping (as they are inherited from base mapping (but disable and redefine are allowed)); 3) changes to a base mapping are automatically covered in an overlay mapping (except for disabled mapping elements).

In some implementations, consequences for runtime include: 1) step 1 (first release): each overlay mapping produces its own XSLT mapping (base mapping plus overlay mapping) and 2) (optional) step 2: evaluate options of reuse of base mapping XSLT in runtime.

A user can refer in an overlay MAG to an underlying Base MAG. A UI extension plus new field in MAG JavaScript Object Notation (JSON) plus store dependency in a data store (e.g., as metadata).

In some implementations, a user can select/deselect mapping elements in a MAG.
Existing implementation can be used for proposed mapping elements.
Existing implementation might need to be extended/refactored.
Only selected mapping elements will be considered by consumers (e.g., XSLT, PDF, etc.),
XSLT and Simulation must work as expected.
At MAG Load:
   Add all mapping elements from Base MAG to the MAG JSON.
   Have a new attribute for mapping elements to declare it as a Base mapping element.
   Set all base mapping elements to “, Selected” except the ones previously deselected.
At MAG Save:
   Remove all selected mapping elements from Base MAG from the MAG JSON
   But store which base mapping elements were deselected

In some implementations, automatic basic conflict resolution can be used to avoid user troubleshooting and to make overlay mapping as error-free as possible in most situations.
If source or target node for a base mapping don't exist, automatically deselect base mapping element
If both base and overlay mapping have a selected mapping element for the same target node, automatically deselect base mapping element (e.g., could possibly happen if new mapping element is added to base mapping at a later time).
With other know or unknown conflict situations.

In some implementations, a base MAG is automatically included in any Export/ Import. A use can also manually ensure that a base MAG is exported/imported.

In some implementations, different MIGs can be used in base and overlay MAGs.

In some implementations, additional functionality available can include and activation and proposal service, enhanced mapping control to distinguish between base and overlay mappings, PDF documentation, and to replace a MIG in a MAG.

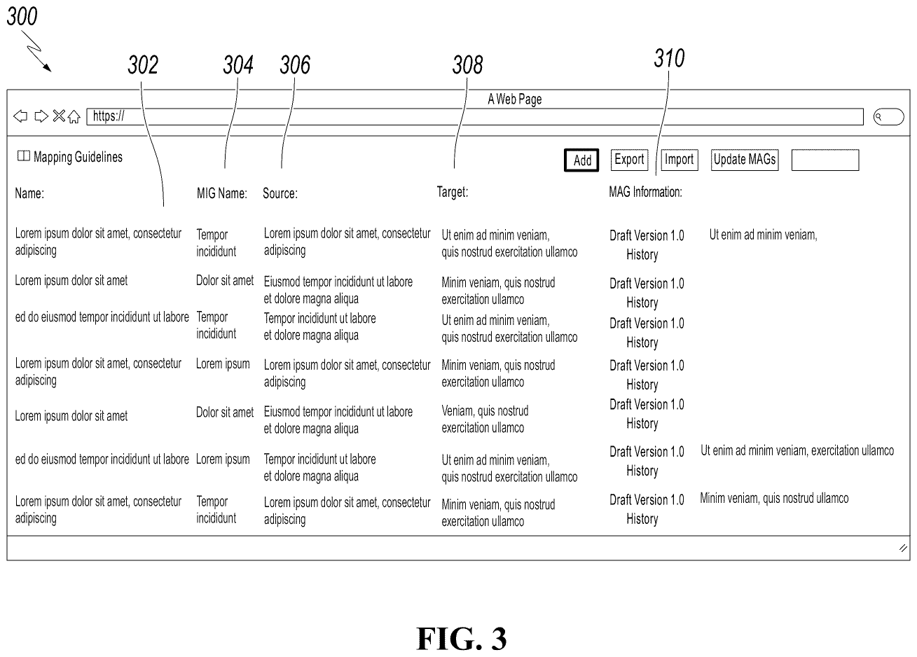

Turning to FIG. 3, FIG. 3 is an example of mapping guidelines 300 UI, according to an implementation of the present disclosure. In FIG. 3, different mapping guidelines can be identified in column 302. Associated MIG(s) are in column 304. Source and target data MIGS are in 306 and 308, respectively. MAG information (e.g., version and history) are in column 310.

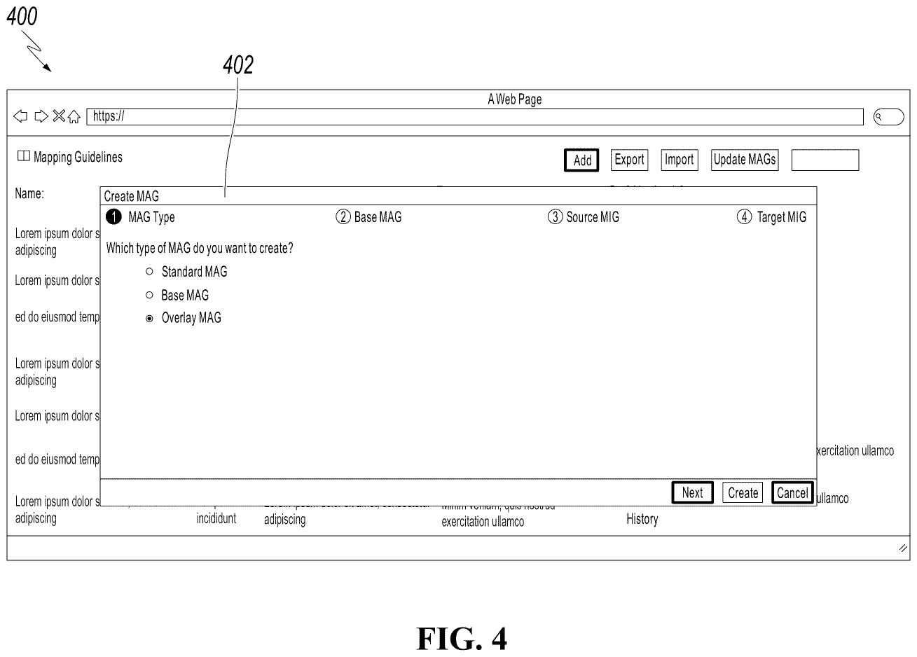

FIG. 4 is an example of a UI 400 for selecting a MAG type, according to an implementation of the present disclosure. In FIG. 4, a dialog 402 can be presented to permit a user to select different types of mapping guidelines to create (e.g., a standard, base, or overlay MAG).

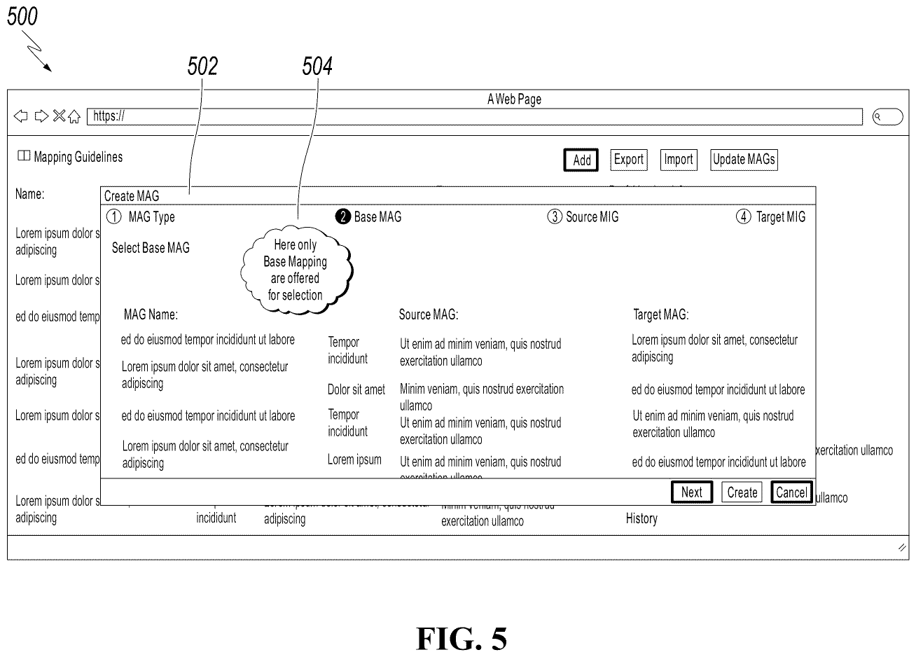

FIG. 5 is an example of a UI 500 for selecting a base MAG, according to an implementation of the present disclosure. In FIG. 5, a dialog 502 can be presented to permit a user to select a base MAG 504 to perform mapping between a source and target data package.

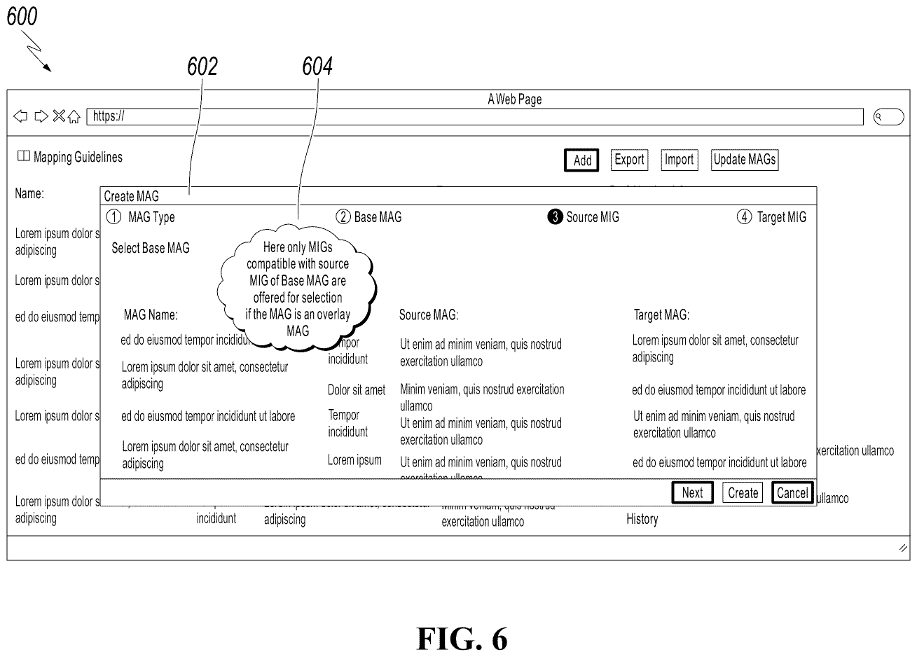

FIG. 6 is an example of a UI 600 for selecting a source MIG, according to an implementation of the present disclosure. In FIG. 6, a dialog 602 can be presented to permit a user to select a source MIG 604 to perform mapping between a source and target data package.

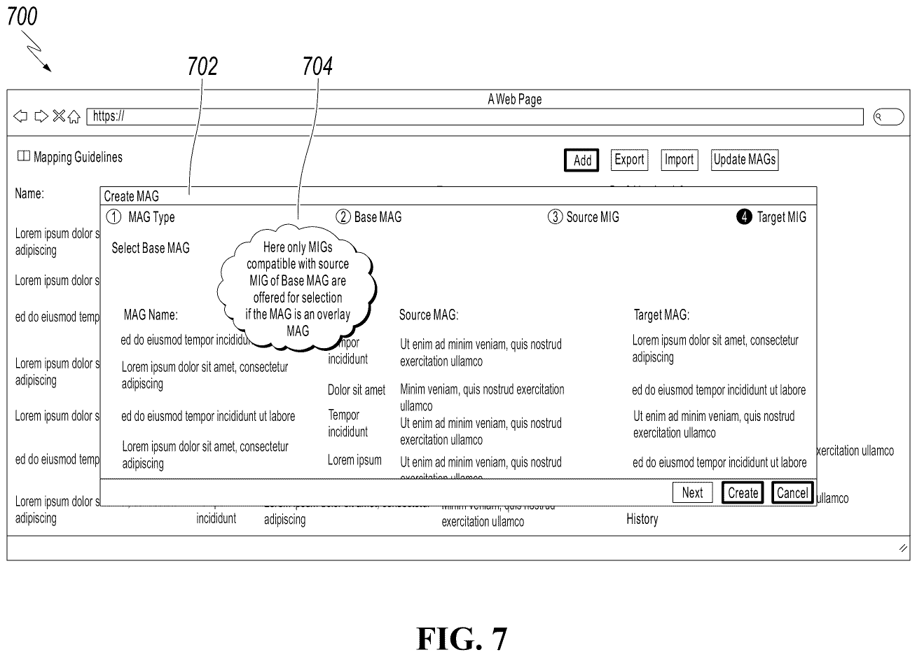

FIG. 7 is an example of a UI 700 for selecting a target MIG, according to an implementation of the present disclosure. In FIG. 7, a dialog 702 can be presented to permit a user to select a target MIG 704 to perform mapping between a source and target data package.

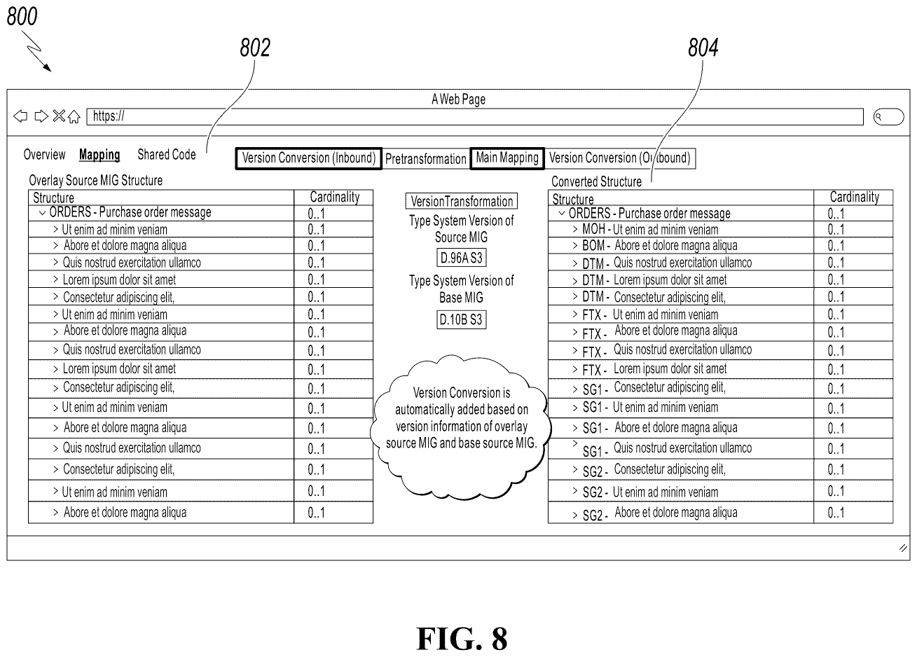

FIG. 8 is an example of a UI 800 for performing version conversion, according to an implementation of the present disclosure. In FIG. 8, UI 800 can be presented to permit a user to select a target MIG 704 to perform mapping between an overlay source MIG structure 802 and a converted structure 804. In some implementations, version conversion is automatically added based on version information of an overlay source MIG and a base source MIG.

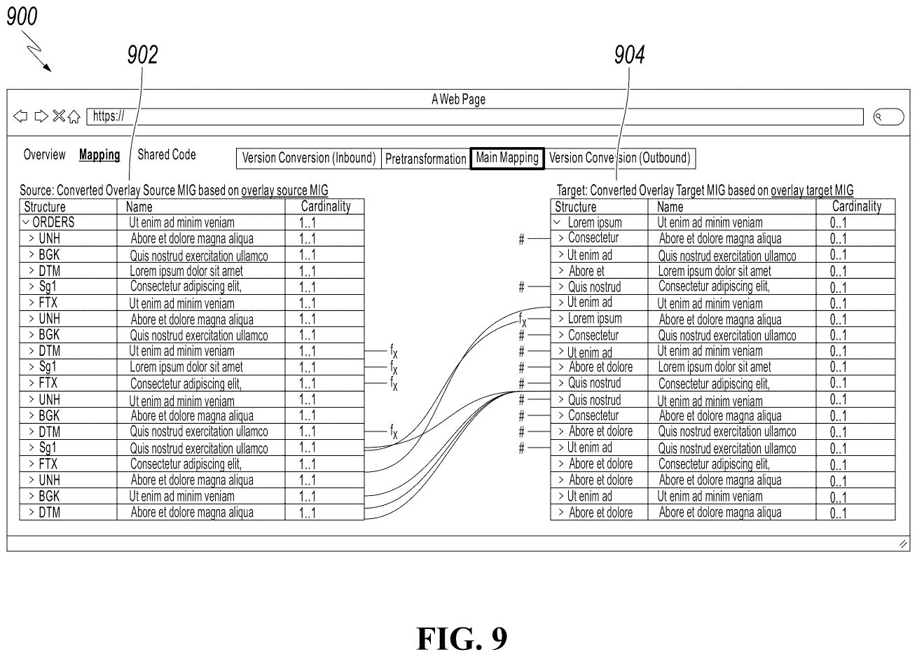

FIG. 9 is an example of a UI 900 for performing a main mapping, according to an implementation of the present disclosure. In FIG. 9, UI 900 can be presented to permit a user to map between a source (converted overlay source MIG based on an overlay source MIG) 902 and a target (converted overlay target MIG based on an overlay target MIG) 904. In some implementations, version conversion is automatically added based on version information of an overlay source MIG and a base source MIG.

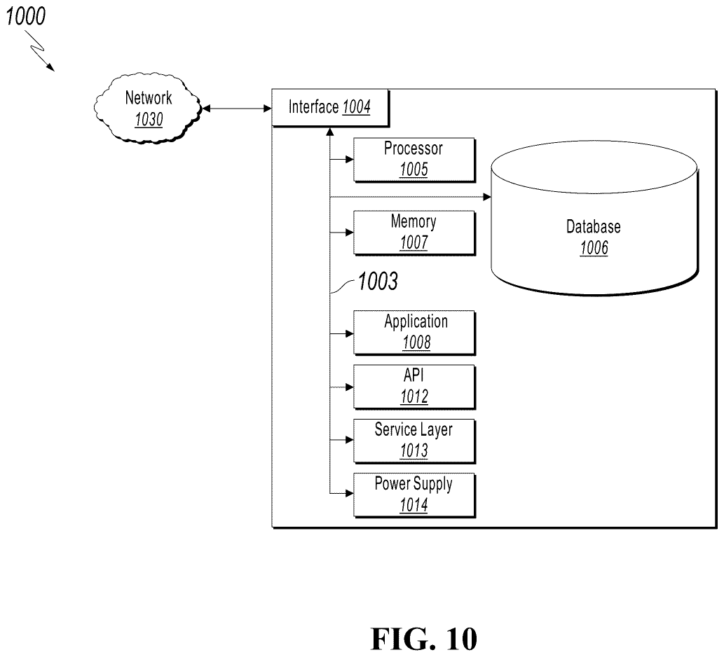

FIG. 10 is a block diagram illustrating an example of a computer-implemented System 1000 used to provide computational functionalities associated with described algorithms, methods, functions, processes, flows, and procedures, according to an implementation of the present disclosure. In the illustrated implementation, computer-implemented system 1000 includes a Computer 1002 and a Network 1030.

The illustrated Computer 1002 is intended to encompass any computing device, such as a server, desktop computer, laptop/notebook computer, wireless data port, smart phone, personal data assistant (PDA), tablet computer, one or more processors within these devices, or a combination of computing devices, including physical or virtual instances of the computing device, or a combination of physical or virtual instances of the computing device. Additionally, the Computer 1002 can include an input device, such as a keypad, keyboard, or touch screen, or a combination of input devices that can accept user information, and an output device that conveys information associated with the operation of the Computer 1002, including digital data, visual, audio, another type of information, or a combination of types of information, on a graphical-type user interface (UI) (or GUI) or other UI.

The Computer 1002 can serve in a role in a distributed computing system as, for example, a client, network component, a server, or a database or another persistency, or a combination of roles for performing the subject matter described in the present disclosure. The illustrated Computer 1002 is communicably coupled with a Network 1030. In some implementations, one or more components of the Computer 1002 can be configured to operate within an environment, or a combination of environments, including cloud-computing, local, or global.

At a high level, the Computer 1002 is an electronic computing device operable to receive, transmit, process, store, or manage data and information associated with the described subject matter. According to some implementations, the Computer 1002 can also include or be communicably coupled with a server, such as an application server, e-mail server, web server, caching server, or streaming data server, or a combination of servers.

The Computer 1002 can receive requests over Network 1030 (for example, from a client software application executing on another Computer 1002) and respond to the received requests by processing the received requests using a software application or a combination of software applications. In addition, requests can also be sent to the Computer 1002 from internal users (for example, from a command console or by another internal access method), external or third-parties, or other entities, individuals, systems, or computers.

Each of the components of the Computer 1002 can communicate using a System Bus 1003. In some implementations, any or all of the components of the Computer 1002, including hardware, software, or a combination of hardware and software, can interface over the System Bus 1003 using an application programming interface (API) 1012, a Service Layer 1013, or a combination of the API 1012 and Service Layer 1013. The API 1012 can include specifications for routines, data structures, and object classes. The API 1012 can be either computer-language independent or dependent and refer to a complete interface, a single function, or even a set of APIs. The Service Layer 1013 provides software services to the Computer 1002 or other components (whether illustrated or not) that are communicably coupled to the Computer 1002. The functionality of the Computer 1002 can be accessible for all service consumers using the Service Layer 1013. Software services, such as those provided by the Service Layer 1013, provide reusable, defined functionalities through a defined interface. For example, the interface can be software written in a computing language (for example JAVA or C++) or a combination of computing languages, and providing data in a particular format (for example, extensible markup language (XML)) or a combination of formats. While illustrated as an integrated component of the Computer 1002, alternative implementations can illustrate the API 1012 or the Service Layer 1013 as stand-alone components in relation to other components of the Computer 1002 or other components (whether illustrated or not) that are communicably coupled to the Computer 1002. Moreover, any or all parts of the API 1012 or the Service Layer 1013 can be implemented as a child or a sub-module of another software module, enterprise application, or hardware module without departing from the scope of the present disclosure.

The Computer 1002 includes an Interface 1004. Although illustrated as a single Interface 1004, two or more Interfaces 1004 can be used according to particular needs, desires, or particular implementations of the Computer 1002. The Interface 1004 is used by the Computer 1002 for communicating with another computing system (whether illustrated or not) that is communicatively linked to the Network 1030 in a distributed environment. Generally, the Interface 1004 is operable to communicate with the Network 1030 and includes logic encoded in software, hardware, or a combination of software and hardware. More specifically, the Interface 1004 can include software supporting one or more communication protocols associated with communications such that the Network 1030 or hardware of Interface 1004 is operable to communicate physical signals within and outside of the illustrated Computer 1002.

The Computer 1002 includes a Processor 1005. Although illustrated as a single Processor 1005, two or more Processors 1005 can be used according to particular needs, desires, or particular implementations of the Computer 1002. Generally, the Processor 1005 executes instructions and manipulates data to perform the operations of the Computer 1002 and any algorithms, methods, functions, processes, flows, and procedures as described in the present disclosure.

The Computer 1002 also includes a Database 1006 that can hold data for the Computer 1002, another component communicatively linked to the Network 1030 (whether illustrated or not), or a combination of the Computer 1002 and another component. For example, Database 1006 can be an in-memory or conventional database storing data consistent with the present disclosure. In some implementations, Database 1006 can be a combination of two or more different database types (for example, a hybrid in-memory and conventional database) according to particular needs, desires, or particular implementations of the Computer 1002 and the described functionality. Although illustrated as a single Database 1006, two or more databases of similar or differing types can be used according to particular needs, desires, or particular implementations of the Computer 1002 and the described functionality. While Database 1006 is illustrated as an integral component of the Computer 1002, in alternative implementations, Database 1006 can be external to the Computer 1002. The Database 1006 can hold and operate on at least any data type mentioned or any data type consistent with this disclosure.

The Computer 1002 also includes a Memory 1007 that can hold data for the Computer 1002, another component or components communicatively linked to the Network 1030 (whether illustrated or not), or a combination of the Computer 1002 and another component. Memory 1007 can store any data consistent with the present disclosure. In some implementations, Memory 1007 can be a combination of two or more different types of memory (for example, a combination of semiconductor and magnetic storage) according to particular needs, desires, or particular implementations of the Computer 1002 and the described functionality. Although illustrated as a single Memory 1007, two or more Memories 1007 or similar or differing types can be used according to particular needs, desires, or particular implementations of the Computer 1002 and the described functionality. While Memory 1007 is illustrated as an integral component of the Computer 1002, in alternative implementations, Memory 1007 can be external to the Computer 1002.

The Application 1008 is an algorithmic software engine providing functionality according to particular needs, desires, or particular implementations of the Computer 1002, particularly with respect to functionality described in the present disclosure. For example, Application 1008 can serve as one or more components, modules, or applications. Further, although illustrated as a single Application 1008, the Application 1008 can be implemented as multiple Applications 1008 on the Computer 1002. In addition, although illustrated as integral to the Computer 1002, in alternative implementations, the Application 1008 can be external to the Computer 1002.

The Computer 1002 can also include a Power Supply 1014. The Power Supply 1014 can include a rechargeable or non-rechargeable battery that can be configured to be either user-or non-user-replaceable. In some implementations, the Power Supply 1014 can include power-conversion or management circuits (including recharging, standby, or another power management functionality). In some implementations, the Power Supply 1014 can include a power plug to allow the Computer 1002 to be plugged into a wall socket or another power source to, for example, power the Computer 1002 or recharge a rechargeable battery.

There can be any number of Computers 1002 associated with, or external to, a computer system containing Computer 1002, each Computer 1002 communicating over Network 1030. Further, the term “client,” “user,” or other appropriate terminology can be used interchangeably, as appropriate, without departing from the scope of the present disclosure. Moreover, the present disclosure contemplates that many users can use one Computer 1002, or that one user can use multiple computers 1002.

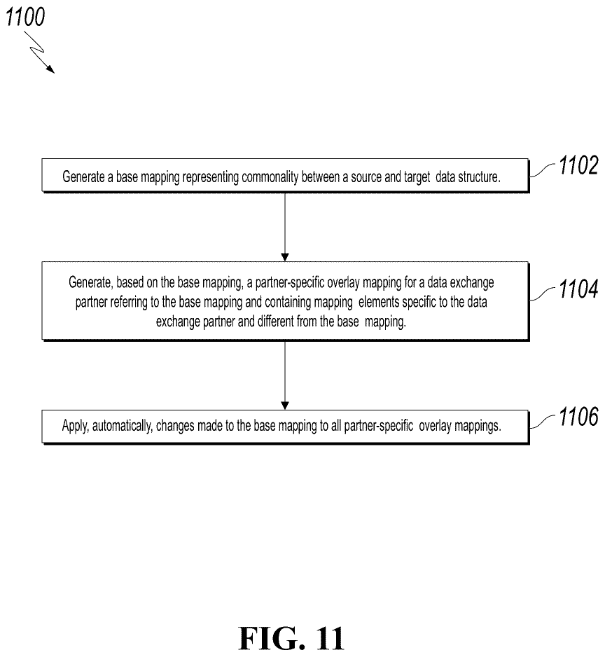

FIG. 11 is a flowchart illustrating an example of a computer-implemented method 1100 for efficient mass modeling of mappings in electronic data interchange (EDI), according to an implementation of the present disclosure. For clarity of presentation, the description that follows generally describes method 1100 in the context of the other figures in this description. However, it will be understood that method 1100 can be performed, for example, by any system, environment, software, and hardware, or a combination of systems, environments, software, and hardware, as appropriate. In some implementations, various steps of method 1100 can be run in parallel, in combination, in loops, or in any order.

At 1102 a base mapping representing commonality between a source and target data structure is generated. In some implementations, generating a base mapping representing commonality between a source and target data structure is performed automatically by a computer software application. From 1102, method 1100 proceeds to 1104.

At 1104, based on the base mapping, a partner-specific overlay mapping is generated for a data exchange partner referring to the base mapping and containing mapping elements specific to the data exchange partner and different from the base mapping. In some implementations, generating, based on the base mapping, a partner-specific overlay mapping permits at least one of: 1) keeping a mapping element; 2) defining a new mapping element; 3) disabling/removing a mapping element; and 4) replacing a mapping element. In some implementations, an executable based on the base and partner-specific overlay mappings is generated. In some implementations, the executable can be executed by an extensible stylesheet language transformation (XSLT). In some implementations, generating an executable based on the base and partner-specific overlay mappings are performed by either 1) as a combined base/partner-specific overlay mapping or 2) where a partner-specific overlay executable uses a base mapping executable. In some implementations, base mapping elements cannot be changed in a partner-specific overlay mapping as they are inherited from the base mapping. From 1104, method 1100 proceeds to 1106.

At 1106, changes made to the base mapping are automatically applied to all partner-specific overlay mappings. After 1106, method 1100 can stop.

Described implementations of the subject matter can include one or more features, alone or in combination.

For example, in a first implementation, a computer-implemented method for electronic data interchange (EDI), comprising: generating a base mapping representing commonality between a source and target data structure; generating, based on the base mapping, a partner-specific overlay mapping for a data exchange partner referring to the base mapping and containing mapping elements specific to the data exchange partner and different from the base mapping; and applying, automatically, changes made to the base mapping to all partner-specific overlay mappings.

For example, in a second implementation, a non-transitory, computer-readable medium storing one or more instructions executable by a computer system to perform one or more operations for electronic data interchange (EDI), comprising: generating a base mapping representing commonality between a source and target data structure; generating, based on the base mapping, a partner-specific overlay mapping for a data exchange partner referring to the base mapping and containing mapping elements specific to the data exchange partner and different from the base mapping; and applying, automatically, changes made to the base mapping to all partner-specific overlay mappings.

For example, in a third implementation, a computer-implemented system for electronic data interchange (EDI), comprising: one or more computers; and one or more computer memory devices interoperably coupled with the one or more computers and having tangible, non-transitory, machine-readable media storing one or more instructions that, when executed by the one or more computers, perform one or more operations, comprising: generating a base mapping representing commonality between a source and target data structure; generating, based on the base mapping, a partner-specific overlay mapping for a data exchange partner referring to the base mapping and containing mapping elements specific to the data exchange partner and different from the base mapping; and applying, automatically, changes made to the base mapping to all partner-specific overlay mappings.

The foregoing and other described implementations can each, optionally, include one or more of the following features:

A first feature, combinable with any of the following features, wherein generating a base mapping representing commonality between a source and target data structure is performed automatically by a computer software application.

A second feature, combinable with any of the previous or following features, wherein generating, based on the base mapping, a partner-specific overlay mapping permits at least one of: 1) keeping a mapping element; 2) defining a new mapping element; 3) disabling/removing a mapping element; and 4) replacing a mapping element.

A third feature, combinable with any of the previous or following features, comprising generating an executable based on the base and partner-specific overlay mappings.

A fourth feature, combinable with any of the previous or following features, wherein the executable can be executed by an extensible stylesheet language transformation (XSLT).

A fifth feature, combinable with any of the previous or following features, wherein generating an executable based on the base and partner-specific overlay mappings are performed by either 1) as a combined base/partner-specific overlay mapping or 2) where a partner-specific overlay executable uses a base mapping executable.

A sixth feature, combinable with any of the previous or following features, wherein base mapping elements cannot be changed in a partner-specific overlay mapping as they are inherited from the base mapping.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed. The computer storage medium is not, however, a propagated signal.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” “computing device,” or “electronic computer device” (or an equivalent term as understood by one of ordinary skill in the art) refer to data processing hardware and encompass all kinds of apparatuses, devices, and machines for processing data, including by way of example, a programmable processor, a computer, or multiple processors or computers. The computer can also be, or further include special-purpose logic circuitry, for example, a central processing unit (CPU), a field-programmable gate array (FPGA), or an application-specific integrated circuit (ASIC). In some implementations, the computer or computer-implemented system or special-purpose logic circuitry (or a combination of the computer or computer-implemented system and special-purpose logic circuitry) can be hardware-or software-based (or a combination of both hardware-and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system, for example LINUX, UNIX, WINDOWS, MAC OS, ANDROID, or IOS, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special-purpose logic circuitry, for example, a CPU, an FPGA, or an ASIC.

Computers for the execution of a computer program can be based on general or special-purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device, for example, a universal serial bus (USB) flash drive, to name just a few.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital versatile/video disc (DVD), compact disc (CD)-ROM, DVD+/-R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special-purpose logic circuitry.

To provide for interaction with a user, implementations of the subject matter described in this specification can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity or a multi-touch screen using capacitive or electric sensing. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface (GUI) can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11x or other protocols, all or a portion of the Internet, another communication network, or a combination of communication networks. The communication network can communicate with, for example, Internet Protocol (IP) packets, frame relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

The separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

1. A computer-implemented method for electronic data interchange (EDI), comprising:
generating a base mapping representing commonality between a source and target data structure;
generating, based on the base mapping, a partner-specific overlay mapping for a data exchange partner referring to the base mapping and containing mapping elements specific to the data exchange partner and different from the base mapping;
applying, automatically, changes made to the base mapping to all partner-specific overlay mappings; and
generating an executable based on the base mapping and the partner-specific overlay mapping, wherein the generating is performed by configuring a partner-specific overlay executable to use a base mapping executable.

2. The computer-implemented method of claim 1, wherein generating a base mapping representing commonality between a source and target data structure is performed automatically by a computer software application.

3. The computer-implemented method of claim 1, wherein generating, based on the base mapping, a partner-specific overlay mapping permits at least one of: 1) keeping a mapping element; 2) defining a new mapping element; 3) disabling/removing a mapping element; and 4) replacing a mapping element.

4. (canceled)

5. The computer-implemented method of claim 1, wherein the executable can be executed by an extensible stylesheet language transformation (XSLT).

6. (canceled)

7. The computer-implemented method of claim 1, wherein base mapping elements cannot be changed in a partner-specific overlay mapping as they are inherited from the base mapping.

8. A non-transitory, computer-readable medium storing one or more instructions executable by a computer system to perform one or more operations for electronic data interchange (EDI), comprising:
generating a base mapping representing commonality between a source and target data structure;
generating, based on the base mapping, a partner-specific overlay mapping for a data exchange partner referring to the base mapping and containing mapping elements specific to the data exchange partner and different from the base mapping
applying, automatically, changes made to the base mapping to all partner-specific overlay mappings; and
generating an executable based on the base mapping and the partner-specific overlay mapping, wherein the generating is performed by configuring a partner-specific overlay executable to use a base mapping executable.

9. The non-transitory, computer-readable medium of claim 8, wherein generating a base mapping representing commonality between a source and target data structure is performed automatically by a computer software application.

10. The non-transitory, computer-readable medium of claim 8, wherein generating, based on the base mapping, a partner-specific overlay mapping permits at least one of: 1) keeping a mapping element; 2) defining a new mapping element; 3) disabling/removing a mapping element; and 4) replacing a mapping element.

11. (canceled)

12. The non-transitory, computer-readable medium of claim 8, wherein the executable can be executed by an extensible stylesheet language transformation (XSLT).

13. (canceled)

14. The non-transitory, computer-readable medium of claim 8, wherein base mapping elements cannot be changed in a partner-specific overlay mapping as they are inherited from the base mapping.

15. A computer-implemented system for electronic data interchange (EDI), comprising:
one or more computers; and
one or more computer memory devices interoperably coupled with the one or more computers and having tangible, non-transitory, machine-readable media storing one or more instructions that, when executed by the one or more computers, perform one or more operations, comprising:
generating a base mapping representing commonality between a source and target data structure;
generating, based on the base mapping, a partner-specific overlay mapping for a data exchange partner referring to the base mapping and containing mapping elements specific to the data exchange partner and different from the base mapping
applying, automatically, changes made to the base mapping to all partner-specific overlay mappings; and
generating an executable based on the base mapping and the partner-specific overlay mapping, wherein the generating is performed by configuring a partner-specific overlay executable to use a base mapping executable.

16. The computer-implemented system of claim 15, wherein generating a base mapping representing commonality between a source and target data structure is performed automatically by a computer software application.

17. The computer-implemented system of claim 15, wherein generating, based on the base mapping, a partner-specific overlay mapping permits at least one of: 1) keeping a mapping element; 2) defining a new mapping element; 3) disabling/removing a mapping element; and 4) replacing a mapping element.

18. (canceled)

19. The computer-implemented system of claim 15, wherein:
the executable can be executed by an extensible stylesheet language transformation (XSLT); or
generating an executable based on the base and partner-specific overlay mappings are performed by either 1) as a combined base/partner-specific overlay mapping or 2) where a partner-specific overlay executable uses a base mapping executable.

20. (canceled)
